(19) United States
(12) Patent Application Publication
(10) Pub. No.: US 2009/0028740 A1
(43) Pub. Date: Jan. 29, 2009

(54) METHOD FOR THE PRODUCTION OF SEMICONDUCTOR GRANULES

(75) Inventor: Alain Straboni, Buxerolles (FR)

Correspondence Address: Howard IP Law Group, P.O. Box 226, Fort Washington, PA, 19034, US

(73) Assignee: S'TILE, Buxerolles (FR)

(21) Appl. No.: 12/184,696

(22) Filed: Aug. 1, 2008

Related U.S. Application Data
(63) Continuation-in-part of application No. 10/553,049, filed on Jun. 15, 2006.

(30) Foreign Application Priority Data
Apr. 14, 2003 (FR) 03/04675
Apr. 9, 2004 (FR) PCT/FR2004/050152

(51) Int. Cl. B22F 5/10; B08B 3/08; B08B 5/00

(52) U.S. Cl. 419/2; 134/2

(57) ABSTRACT

A method of manufacturing a semiconductor material in the form of bricks or granules, includes a step of sintering powders of at least one material selected from the group consisting of silicon, germanium, gallium arsenide, and the alloys thereof so as to form said granules. The sintering step includes the steps of compacting and thermal processing the powders, and a step of purifying the semiconductor material using a flow of a gas. The gas flow passes through the porosity channels of the material.

### RELATED APPLICATIONS

This application is a continuation in part of U.S. application Ser. No. 10/553,049, filed Oct. 10, 2005 entitled Method For The Production of Semiconductor Granules which is the national stage application under 35 U.S.C. § 371 of the International Application No. PCT/FR2004/050152, and claims the benefit of French Application No. 03/04675, filed Apr. 14, 2003 and Int'l. Application No. PCT/FR2004/050152, filed Apr. 9, 2004, the entire disclosures of which are incorporated herein by reference in their entireties.

### FIELD OF THE INVENTION

The present invention relates to the field of semiconductor materials, and in particular, but not exclusively, semiconductor granules usable to feed a melt intended for the forming of ingots of a semiconductor material, such as silicon.

### BACKGROUND OF THE INVENTION

Conventionally, single-crystal silicon or polysilicon ingots are obtained by growth or stretching from silicon melts. Such melts are fed with silicon granules or pieces of a size greater than 1 mm. Indeed, if a silicon melt is fed with smaller particles, the particles very uneasily incorporate to the melt, which adversely affects the smooth progress of the process.

A conventional example of granule manufacturing is the following. In a chemical vapor deposition reactor (CVD), silane (SiH₄) or trichlorosilane (SiHCl₃) gas is cracked, that is, heated so that its molecule is broken. Solid silicon is then released and deposits in the form of powders. At the beginning of the process, the obtained powders are very thin, typically on the order of a few tens of nanometers. To have the grains of these powders grow bigger, specific conditions must be implemented, which complexities the method and equipments. Fluidized bed deposition machines which enable growth of the powder grains up to from one to two millimeters are for example used.

The above-described method is long and consumes a great amount of power. The selfcost of granules is high. Further, this manufacturing process leaves residues in the form of very thin powders, much smaller than one millimeter, unexploited up to now.

### SUMMARY OF THE INVENTION

An aspect of the invention includes a method for manufacturing granules adapted to feeding a semiconductor material ingot manufacturing melt, which is fast, inexpensive, and consumes little power.

The present invention provides, according to an aspect, a method of manufacturing semiconductor granules intended to feed a semiconductor material manufacturing melt. The method comprises a method of sintering and/or melting of semiconductor powders.

According to an embodiment of the present invention, the granules have a size greater than 1 mm.

According to an embodiment of the present invention, the powders include powders of nanometric and/or micrometric size.

According to an embodiment of the present invention, the method includes a compaction step followed with a thermal processing step.

According to an embodiment of the present invention, the pressure ranges between 10 MPa and 1 GPa and the temperature is greater than 800° C.

According to an embodiment of the present invention, the method includes a hot pressing step.

According to an embodiment of the present invention, in the hot pressing step, the pressure is lower than 100 MPa and the temperature is greater than 800° C.

According to an embodiment of the present invention, the method includes a step of placing the powders in a mould.

According to an embodiment of the present invention, the powders are doped semiconductor powders.

According to an embodiment of the present invention, the method includes a step of anneal or doping of the granules.

### BRIEF DESCRIPTION OF THE DRAWINGS

The foregoing and other objects, features, and advantages of the present invention will be discussed in detail in the following non-limiting description of specific embodiments in connection with the accompanying drawings, among which:

FIGS. 1A to 1F illustrate the manufacturing of granules according to the present invention;

FIGS. 2A and 2B illustrate an exemplary method according to an embodiment of the present invention;

FIG. 3 shows an exemplary granule obtained according to an embodiment of the present invention;

FIG. 4 illustrates another exemplary method according to an embodiment of the present invention;

FIG. 5 shows an exemplary brick produced by a method of the present invention;

FIG. 6 shows a mould used to produce the brick of FIG. 5;

FIG. 7 shows another exemplary brick produced by a method of the present invention;

FIG. 8 shows an assembly used for producing materials according to an embodiment of the present invention; and

FIG. 9 shows a device used for producing materials according to an embodiment of the present invention.

### DETAILED DESCRIPTION OF EXEMPLARY EMBODIMENTS OF THE INVENTION

To manufacture inexpensive granules, within a short time and while consuming little power, the inventor has thought of sintering or melting semiconductor powders.

The powders used, for example, are powders of nanometric size (from 10 to 500 nm) or micrometric size (from 10 to 500 μm) coming from the CVD reactors. Silicon wafer sawing residues, which also include powders of nanometric and micrometric size, may also be used.

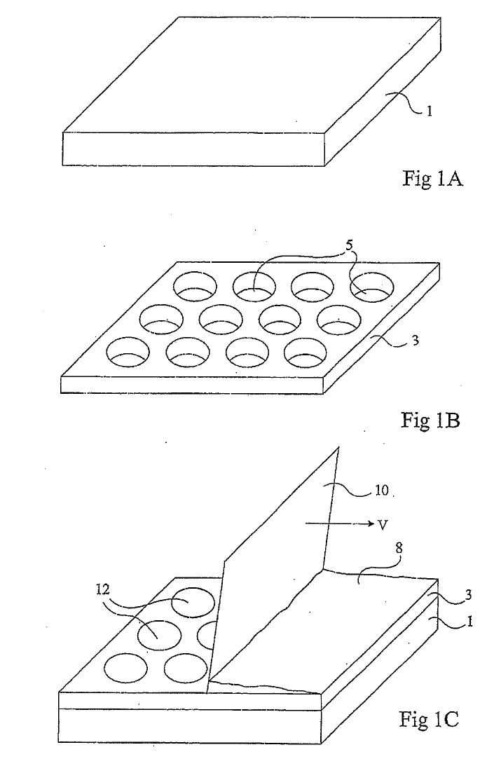

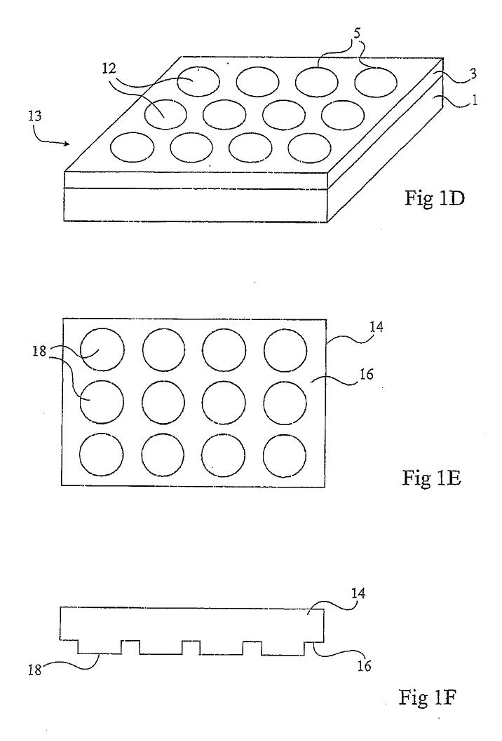

The granule manufacturing according to an embodiment of the present invention will now be described in relation with FIGS. 1A to 1F.

FIG. 1A shows a planar parallelepipedal-shaped support 1. Support 1 is intended to be a compression part and it is formed, for example, with a graphite blade, or another ceramic. To form support 1, silicon nitride (Si₃N₄), silicon carbide (SiC), boron nitride (BN), alumina, zirconia, magnesia, etc. may, for example, be used.

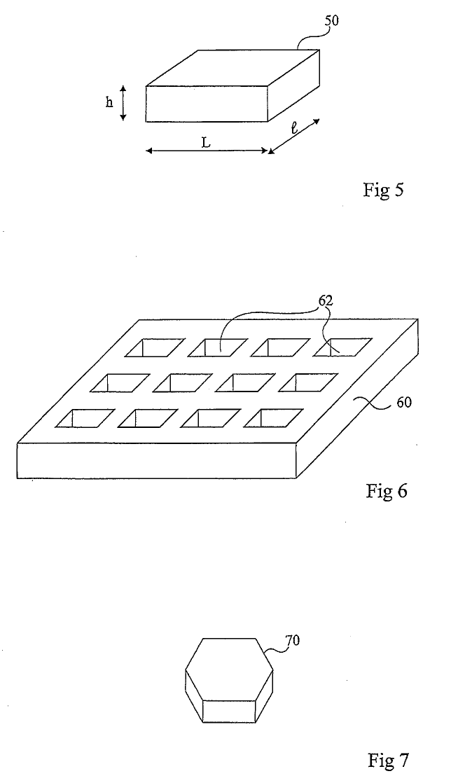

A mould 3, shown in FIG. 1B, is placed above support 1 of FIG. 1A. Mould 3 is a plate pierced with openings 5. The openings 5 shown in FIG. 1B have a circular cross-section. Typically, the thickness of mould 3 is on the order of from one to a few millimeters, and the diameter of openings 5, for example, ranges between 1 and 5 millimeters. The thickness of mould 3 is generally greater than the desired thickness of the granules 24 (of FIG. 3) or bricks 50 (of FIG. 5) and 70 (of FIG. 7) of material, and is preferably only slightly greater than the desired thickness of the granules and bricks, thereby providing a compact and efficient design.

Then, as shown in FIG. 1C, the assembly formed by the superposition of support 1 and mould 3 is covered with semiconductor material powders 8. Semiconductor powders 8 are scraped by a scraping element 10 in the direction of arrow V. Element 10 scrapes powders 8 and, after passing thereof, openings 5 of mould 3 are filled with powders 12.

As shown in FIG. 1D, an assembly 13 formed by support 1 topped with mould 3 having its openings 5 filled with powders 12 is obtained.

A plate 14 is placed above assembly 13. Plate 14 may be formed of the same material as support 1. Plate 14 exhibits, on its lower surface shown in FIG. 1E, a planar surface 16 from which are salient protrusions 18 complementary with openings 5 and less high than openings 5 are deep.

FIG. 1F shows plate 14 in cross-section. Protrusions 18 are formed by cylinder elements of a diameter slightly smaller than openings 5. The position of protrusions 18 is the same as that of openings 5. Plate 14 is placed above assembly 13 of FIG. 1D, so that protrusions 18 are above openings 5, filled with silicon powder 12.

Several exemplary methods according to several embodiments of the present invention for manufacturing the granules will now be described.

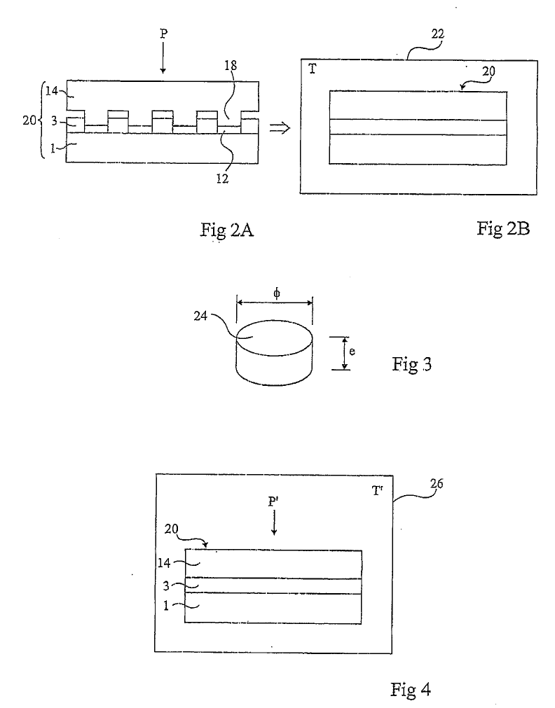

FIG. 2A shows in cross-section view an assembly 20 formed by support 1, mould 3 including silicon powders 12, and plate 14. A pressure P is exerted on elements 1 and 14. Pressure P ensures a compacting of silicon powders 12 contained in mould 3, protrusions 18 of plate 14 penetrating into openings 5 of mould 3 and compressing powders 12. Due to the compacting, a consolidation process starts. After compaction, as illustrated in FIG. 2B, assembly 20 is placed in an anneal furnace 22 where it is submitted to a thermal processing at a temperature T. For simplicity, assembly 20 is shown in simplified fashion in FIG. 2A, where protrusions 18 in particular have not been shown. A sintering occurs in furnace 22 and obtained granules 24 (of FIG. 3) have excellent mechanical strength.

The pressure exerted in the compression step of FIG. 2A may vary within a wide range of values, for example, from 100 bars (10 megapascals) to 10,000 bars (1 gigapascal). The temperature used in the thermal processing of FIG. 2B may also vary within a wide range of values. For example, it may be on the order of 1,000° C.

Generally, the higher the pressure in the compression step, the weaker the thermal anneal can be. The granules having undergone a high-temperature thermal processing exhibit a better mechanical strength.

It should however be noted that, since the powder consolidation starts at room temperature, it can be envisaged to obtain granules by mere cold compaction, that is, at room temperature, of the powders. It should however be noted that non-annealed granules are fragile and, unless they are handled with care, they risk crumbling away during their transportation to the melt.

It can also be envisaged not to compact powders 12, and to bring assembly 20 in furnace 22 to a temperature that can reach the melting temperature of the material, 1,410° C. in the case of silicon. In this case, upper plate 14 is unnecessary. If support 1 is graphite, the silicon should not be melted, since the obtained granule may remain welded to support 1.

FIG. 3 shows a granule 24 obtained by the method of FIG. 2. Granule 24 appears in the form of a cylindrical pellet of thickness e smaller than the thickness of mould 3 and of a diameter substantially equal to the diameter of openings 5 of mould 3. To give an idea, thickness e is from 1 to 3 millimeters and diameter ( ) is on the order of from 1 to 5 mm. Thus, mould 3 also has a thickness of at least, and slightly greater than, 1 to 3 millimeters.

If they have not been annealed up to the melting point, granules 24 obtained by the method of FIG. 2 exhibit a relatively high porosity, generally ranging between 20 and 40%. It is an interconnected porosity, also said to be an open porosity, that is to say, porosity channels are present throughout the entire granule and emerge outside. This feature may be taken advantage of in several ways, for example, for purification or doping.

Indeed, if granules 24 include impurities, for example, due to a pollution of silicon powders 8, granules 24 may be submitted to a subsequent thermal processing to have the impurities migrate to the outside of granules 24 via the porosity channels (not shown).

Also, a dopant gas may be flowed in a subsequent anneal to dope granules 24. Since the gas uniformly spreads throughout granule 24 bulk due to its interconnected porosity, a homogenous doping of granule 24 is obtained across its bulk. Granules 24 may also be doped by forming granules 24 from already doped semiconductor powders 8. It should be noted that the conventional granules generated in CVD reactors are not doped and that granules 24 can be easily doped is an additional advantage of the present invention.

FIG. 4 shows a variation of the method for manufacturing granules 24 according to an aspect of the present invention. Assembly 20, here again shown in simplified fashion and formed, as it should be reminded, of support 1, of mould 3 filled with silicon powders (not shown), and of plate 14, is placed in an enclosure 26, in which the silicon powders (not shown) are submitted to a hot compaction step. For this purpose, a pressure P′ is exerted on or between elements 1 and 14, while assembly 20 is submitted to a thermal processing at temperature T′. Pressure P′ may be exerted for the entire duration of the thermal processing or only for a portion of this processing.

The method of FIG. 4 is remarkable in that the granules are almost immediately obtained. For example, when pressure P′ is exerted for approximately 1 second and it is heated up to 1,200° C. for approximately 1 minute, granules with a very high mechanical strength are obtained rapidly and very economically. Further, pressure P′ may be much lighter than pressure P of FIG. 2 to obtain granules substantially exhibiting the same mechanical strength. For example, a pressure P′ smaller than 30 MPa (300 bars) is perfectly appropriate. Temperature T′ may be on the order of magnitude of temperature T, for example, between 800° C. and the melting temperature of silicon (1,410° C.).

The granules obtained by the method of FIG. 4 are of the same type as granules 24 (of FIG. 3) obtained by the method of FIG. 2. However, their porosity is generally smaller, for example, 10% or less. If the advantages linked to a high porosity of the granules are desired to be kept, it must be ascertained that the porosity not be too small.

The size of the obtained granules is not critical. It is enough for the granules to be big enough to be able to feed the melts where the silicon ingots are produced. In practice, it is enough for their size to be millimetric, for example, on the order of from one to a few millimeters. If need be, granules of larger dimension may be obtained by mere increase in the size of openings 5 of mould 3.

The shape of the obtained granules is not critical. Although cylindrical granules 24 have been shown, the granules may be in the shape of cubes, of rectangle parallelepipeds, or other, according to the shape of openings 5 of mould 3. The granules may for example be elongated, bar-shaped, thread-shaped, etc.

The powders 8 used may be nanometric powders, for example, of a diameter on the order of 20 nm, micrometric powders, millimetric powders, or a mixture of powders of various granulometries.

The reaction atmosphere in furnace 22 or enclosure 26 may be vacuum or a controlled pressure of a gas, inert or not, for example, argon, nitrogen, or chlorine. A gas which contains a vapor pressure of an element other than silicon, for example, of another semiconductor, or of a silicon dopant such as boron, phosphorus, or arsenic, may also be used.

Of course, the present invention is likely to have various alterations and modifications which will occur to those skilled in the art.

In particular, it should be noted that the various elements described in relation with FIGS. 1A to 1F are examples only and may undergo many modifications.

For example, plate 14 may exhibit no protrusions 18 if the material forming mould 3 is flexible and/or deformable enough for the powder islets that it encloses to be adequately compressed.

Mould 3 may also be avoided. For example, small powder piles may be placed in spaced fashion on a support. A plate (not shown) is placed on the assembly, which is submitted to the method of FIG. 2 or 4. The small powder piles are crushed by the compression and, if they are distant enough from one another, they will form separated granules.

It should also be noted that it is possible to use not a single mould 3, but several adequately superposed and separated moulds 3. For example, a stacking formed of a support 1, of a mould 3 filed with silicon powders 12, of a plate 14, followed by another mould 3 filled with silicon powders 12, of another plate 14, etc. to form many granules at the same time, may be formed.

The powders used to form the granules may be formed of a mixture of powders of granulometries adapted to a desired compactness. It should also be noted that the method according to the present invention enables manufacturing of not only silicon granules, as described, but also granules of another semiconductor material, such as germanium, or of an alloy, such as gallium arsenide or an alloy of silicon, germanium, and carbon.

Some further embodiments or aspects of the present invention will now be described in relation to FIGS. 5 to 9.

In the present invention, as already mentioned, the granules may have various other forms than cylindrical. For example, the granules may have the form of rectangle parallelepiped bricks, as shown in FIG. 5.

In FIG. 5, a brick 50 is obtained by an exemplary process of the present invention. The brick 50 has a length L, a width I and a height h. The length L can be in the order of ten centimetres, the width I in the order of 5 centimetres, and the height h in the order of about 1 to several centimetres, for example, 5-10 centimetres. Because of their rectangle parallelepiped form, bricks 50 are particularly adapted to be placed in melting pots to be melted for producing ingots of a semiconductor material.

FIG. 6 shows a mould 60 allowing the production of bricks 50. Mould 60 is similar to mould 3 of FIG. 1B, except that cylindrical openings 5 are replaced by rectangle parallelepiped openings 62. Mould 60 is used as mould 3 of FIG. 1B.

FIG. 7 shows a brick 70 with a hexagonal cross-section. Brick 70 can also be easily arranged in a melting-pot without voids. The mould allowing the production of brick 70 is not shown.

According to another aspect of the present invention, the bricks or granules produced by the method of the present invention can be purified if the powders are not pure enough.

The inventor has found that it was possible to purify a porous semiconductor material using a gas flow through the material. At least two factors explain the good results in purification. First, the gas flows through the porosity channels of the material, and reaches substantial parts of the inner volume of the material. Second, due to diffusion, impurities inside the material reach the porosity channels and can be evacuated out of the material by the gas flow. As this will be seen later, the gas which is used for the purification can be a non-reactive gas, or a gas which reacts with impurities of the material. In the latter case, impurities can form, with the gas or other atoms or molecules present or formed in the material, volatile components which are carried out of the material by the gas flow. The purification of the material can be performed during the production of the material, that is, during the sintering of the powders, or after the production of the material. The materials purified according to an aspect of the present invention can be used in the photovoltaic, electronic, or microelectronic field.

The purification of the material allows the use of powders which are not very pure. For example, the powders can be derived from parts of single-crystal or polycrystalline silicon ingots which are not sufficiently pure, like head, tail and edges of the ingots. The source material can also be broken wafers or wafers with defects, at any stage of the fabrication of photovoltaic cells, electronic components or integrated circuits. If the source material is already doped, the purification according to an aspect of the present invention also allows the production of less doped material. Silicon used in metallurgy can also be used in the present invention. For example, silicon including one or some percents of iron can be purified by the present invention.

The source material can, of course, include all or several of the elements mentioned above. If the source material is not already present in the form of powders, the method according to an aspect of the present invention provides a grinding step for providing powders from the source material. The powders can be of various sizes, but a size less than 10 micrometers may be preferred.

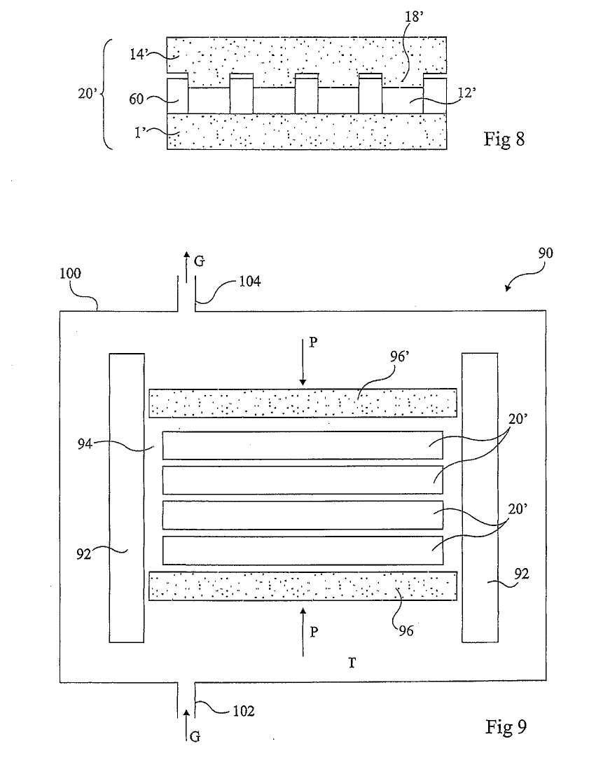

The production of purified bricks according to the present invention will now be described in relation with FIGS. 8 and 9.

FIG. 8 shows, in cross-section view, an assembly 20′ formed by a support 1′, mould 60 having its openings 62 filled with silicon powders 12′, and a plate 14′. FIG. 8 is similar to FIG. 2A, but support 1′ is made of a porous material, allowing the passage of a gas. For example, support 1′ is made of a porous ceramic or graphite. Mould 60 can also be made of a porous material, but it is not necessary. Plate 14′ has protrusions 18′, arranged to penetrate openings 62 of mould 60 for compressing powders 12′. Plate 14′ has the same function as plate 14 of FIGS. 1E, 1F, but is made of a porous material, which can be the same material as the material of support 1′.

FIG. 9 shows a reactor 90 allowing the production and the purification of bricks according to the present invention.

In FIG. 9, reactor 90 includes a matrix 92 forming a chamber 94. A lower plate 96 and an upper plate 96′ close chamber 94. Plates 96 and 96′ are made of a porous material. Matrix 92 can be also made of a porous material, but it is not necessary. Matrix 92 and plates 96, 96′ are disposed in an enclosure 100 having at least an input opening 102 for inputting a gas G and a gas output opening 104.

Several assemblies like assembly 20′ of FIG. 8 are arranged in chamber 94, so as to produce a lot of bricks simultaneously.

To produce the bricks, a pressure P is exerted on the plates 96 and 96′. Pressure P ensures a compacting of the silicon powders 12′ contained in mould 60, protrusions 18′ of plate 14′ penetrating into openings 62 of mould 60 and compressing the powders. Due to the compacting, the bricks are already sufficiently robust to be manipulated without crumbling during transfers involving short distances.

Reactor chamber 94 is then submitted to a thermal processing at a temperature T, in order to provide a sintering of the bricks. The thermal processing can be applied, as already explained in relation with FIG. 2B and FIG. 4, during or after the compacting of powders 12′. The pressure exerted in the compression step may vary within a wide range of values, for example, from 10 bars (1 megapascals) to 10,000 bars (1 gigapascal). The temperature used in the thermal processing may also vary within a wide range of values. For example, it may be comprised between 800° C. and 1400° C. for silicon.

As already mentioned, the purification step can be performed during one of the formation steps of the material. Some of the possible operating modes will now be described.

For example, it is possible to perform a hot pressing step of the powders while purification due to gas flow takes place. This has the advantage of purifying the material during the formation of the granules or bricks.

Also, a hot pressing step can be performed in order to form the granules or bricks. Then, the purification step can take place, in the same enclosure as the enclosure used for the hot pressing step, or in a separate enclosure.

Also, a cold pressing step can be first performed. Then, the thermal processing and the purification step can be performed together, or separately. As the brick can already be transferred short distances after the cold pressing step, the cold pressing step can be done out of reactor 90. So, the bricks can be taken out of mould 60 and can be put close to one another in chamber 94 of reactor 90, which allows the production of more bricks at the same time.

Characteristics of the purification step will now be described.

Gas enters enclosure 100 via opening 102. Then, the gas enters chamber 94 through porous plates 96, 96′, and matrix 92 if it is porous. The gas then passes through the assemblies 20′ of chamber 94, via supports 1′, the porosity channels of the material which is being formed, and plates 14′. If moulds 60 are also made of a porous material, gas passes also through moulds 60, which helps in purification.

Instead of being made of porous material, one or more elements among plates 96, 96′, matrix 92, support 1′, mould 60 and plate 14′ may be made of a non porous material pierced with small traversing openings allowing the gas to pass. For example, these opening can be small conduits with a diameter of 0.1 to 1 millimeter.

The purification step, using a gas flow, can be made at any time of the formation of the bricks. For example, it can be performed at the first stages of powder compaction. It can be performed also after a complete sintering of powders 12′. It is just necessary that the porosity of the material remains an open porosity, that is that the porosity channels within the material are interconnected and lead to the outside the material.

The material is better purified if the temperature is high, because impurities have a better mobility and can reach the porosity channels more easily. For example, the temperature may be between 800° C. and the melting temperature of the material. It is thus advantageous to purify the material during one of the thermal processing steps of the sintering process.

Various durations can be used for the purification step. For example, the duration of the purification step will be of about half an hour to one hour after chamber 94 has reached the desired temperature, the duration of which can also be in the order of about half an hour to one hour. The duration of the purification process depends on various factors. For example, if powders have a small size, the porosity channels are close to one another and impurities reach the porosity channels quickly, whereby the material is purified faster.

Various gas pressures can be used, and the gas pressure can change during the purification step.

If the gas pressure is more than one atmosphere, a gas flow occurs naturally between opening 102 and opening 104.

If the gas pressure is less than one atmosphere, the pressure in chamber 94 is a low pressure, for example ranging from 1 to 10 hectopascals. In this case, the gas is pumped at opening 104, for creating the gas flow and evacuating the gas at the outside.

Various sorts of gas can be used.

For example, the gas can be a non-reactive gas, like argon. When a non-reactive gas flows through the porosity channels of the material, impurities which are not or only little linked to the walls of the porosity channels can be detached and carried out of the material by the gas flow. Further, due to diffusion, impurities inside the material but not present in a porosity channel can reach a porosity channel and be evacuated.

Preferably, the gas is at least partly a reactive gas which chemically reacts with a particular type of impurities to provide volatile components at the used temperatures. These volatile components are evacuated outside the material by the gas flow. The gas can also be a mixture of a carrier gas, like argon, and at least one reactive gas.

The type of the reactive gas depends on the type of impurities to be eliminated.

Examples of very polluting impurities of silicon, which are very difficult to eliminate at low cost, are the metallic impurities. These metallic impurities may include titanium (Ti), tungsten (W), molybdenum (Mo), iron (Fe), chromium (Cr) and copper (Cu). The inventor has found that a flow of a gas containing chlorine, like chlorine (Cl₂) or hydrochloric gas (HCl), in the porosity channels of the material, reacts with the atoms of titanium present in the material to form a volatile component, TiCl₄, carried away and evacuated by the gas flow. Atoms of titanium not present in or at the surface of porosity channels can reach a porosity channel due to diffusion, and are then likely to react with the gas. As a result, the purification process of the present invention provides a material without titanium, as all the inner volume of the material can be reach by the porosity channels. A gas containing chlorine can eliminate other impurities than titanium, as the majority of metals, like iron or copper, also react with chlorine. A gas containing fluorine like tetrafluoromethane (CF₄), sulfur hexafluoride (SF₆) or dichlorodifluoromethane (CCl₂F₂), or containing bromine like hydrogen bromide (HBr) can also be used. To eliminate tungsten, a gas containing fluorine may be used, as tungsten forms with fluorine a volatile component, tungsten hexafluoride (WF6), which may be carried out of the material by the gas flow. Molybdenum reacts with tetrafluoromethane (CF₄) to form a volatile component, molybdenum fluoride (MoF₆), which can be evacuated.

Another kind of impurities includes non metallic impurities like oxygen and carbon. Oxygen is mostly present as the oxides which are naturally present at the surface of the powder particles. A gas containing hydrogen reduces the oxides, which are then evacuated outside the material. The gas which is used may be the hydrogen gas (H₂), or a gas containing hydrogen, like the hydrochloric gas (HCl) or the ammoniac gas (NH₃). Carbon is also evacuated by gases containing hydrogen because carbon provides volatile hydrocarbons, like methane (CH₄), depending on the conditions in chamber 94, for example a temperature of about 1000° C. with a mixture of gases containing argon and about 10% of hydrogen H2.

Regarding alkaline-earth impurities, like sodium, calcium, magnesium or manganese, the inventor has noticed that, at the used temperatures, these impurities are substantially evacuated using a mere pumping, without injecting a reactive gas. The injection of a non-reactive gas helps in eliminating these impurities. Further, if a gas containing chlorine is used for eliminating other impurities, chlorine also eliminates alkaline-earth impurities, like sodium and calcium.

Doping elements can be also suppressed by the method of the present invention. Indeed, phosphorus, boron, arsenide, gallium, aluminum can provide volatile complexes with hydrogen, chlorine and/or carbon. For example, an atom of boron can be combined with an atom of hydrogen and a silicon oxide (SiO) particle to form an atom of silicon and a molecule of (HBO) or boric acid (H₃BO₃), which can be evacuated. Boron can also be evacuated using water-vapor. Some doping elements can also be evacuated by the gas flow merely when temperature is high.

It should be noted that the gas which is used can be a mixture of gases, if the gases are compatible at the used temperatures. For example, it is possible to use a gas mixture comprising 95% of argon (Ar), 4% of hydrogen (H₂) and 1% of chlorine (Cl₂). If incompatible gases are to be used, they will be used the one after the other.

It should also be noted that the present invention allows a selective cleaning of impurities, depending on the conditions and on the nature of the gas. Thus, silicon powder with, for example, 10 ppm of boron and 10 ppm of phosphorus can be cleaned of one of the doping elements to become a doped material of the N or P type. The inventor has noted that phosphorus is easily eliminated at temperatures above 1200° C. due to its vaporization. To eliminate boron, a part of water-vapor in argon at a temperature ranging between about 700 to 900° C. can also be used to produce the volatile molecule HBO or boric acid (H₃BO₃).

Further, pumping can be advantageous. Indeed, a component to be eliminated may have a saturating vapor pressure and be in equilibrium with its vapor in a porosity channel of the material. Continuously pumping in this case decreases the vapor pressure and the component to be eliminated produces more and more vapor, which may accelerate the speed of the process for eliminating this component.

Of course, as already mentioned, the present invention is likely to have various alterations and modifications which will occur to those skilled in the art.

In particular, it should be noted that every step of the purification and/or formation of the material can be split into a plurality of steps.

Also, the methods according to various aspects of the present invention may provide other materials than semiconductor materials, and the various purification steps of the present invention may be applied to any porous material.

Also, when the present invention is applied to elaborating materials for the photovoltaic, electronic or microelectronic field, the powders which are used are not necessarily powders of a unique semiconductor. For example, the powders may be powders of silicon mixed with powders of any other element of column IV of the Mendeleev table, like Germanium (Ge), or semiconductor powders mixed to powders of non semiconductor materials, like silica (SiO₂).

1. A method of manufacturing a semiconductor material in the form of bricks or granules, said method comprising a step of:
sintering powders of at least one material selected from the group consisting of silicon, germanium, gallium arsenide, and the alloys thereof, so as to form said granules, said sintering step comprising the steps of:
compacting and thermal processing said powders; and
purifying the semiconductor material using a flow of a gas, the gas flow passing through the porosity channels of the material.

2. The method of claim 1, wherein the gas is a non-reactive gas.

3. The method of claim 1, wherein the gas comprises at least one reactive gas which reacts with the impurities of the material in order to form volatile components which are carried out of the material by the gas flow.

4. The method of claim 3, wherein the gas comprises hydrogen or an element of the halogen family, like fluorine, chlorine or bromine.

5. The method of claim 1, wherein the gas is a mixture of a non-reactive carrier gas and at least one reactive gas.

6. The method of claim 1, wherein the gas flow is produced by pumping, the gas pressure being the atmospheric pressure or a pressure comprised between 1 hectopascal and the atmospheric pressure.

7. The method of claim 1, wherein the gas has a pressure greater than one atmosphere.

8. The method of claim 1, wherein the temperature in the purification step is greater than 800° C.

9. The method of claim 1, wherein the purification step takes place after the sintering process.

10. The method of claim 1, wherein the purification step is simultaneous with at least one compression step and one thermal processing step.

11. The method of claim 1, wherein the step of sintering comprises a compaction step followed with a thermal processing step.

12. The method of claim 11, wherein the pressure of the compaction step ranges between 10 MPa and 1 GPa.

13. The method of claim 1, wherein said compacting and thermal processing steps are performed at the same time defining a hot pressing step.

14. The method of claim 13, wherein, in the hot pressing step, the pressure is lower than 100 MPa and the temperature is greater than 800° C.

15. The method of claim 1, further comprising a step of placing the powders in a mould.

16. The method of claim 15, wherein said mould comprises a plate having a plurality of openings.

17. The method of claim 15, wherein said mould has a thickness of about 1 to 10 centimetres.

18. The method of claim 1, wherein the powders comprise powders of at least one of nanometric and micrometric sizes.

19. The method of claim 1, wherein said powders are sized in the range of about 10 nm to 500 nm.

20. The method of claim 1, wherein said powders are sized less then 10 μm.

21. The method of claim 1, wherein said powders are sized in the range of about 10 μm to 500 μm.

22. The method of claim 1, wherein the material is a rectangle parallelepiped brick.

23. The method of claim 22, wherein said rectangle parallelepiped brick has a length in the order of ten centimetres, and/or a width in the order of 5 centimetres, and/or a height in the order of about 1 centimetre.

24. The method of claim 1, wherein the material is a brick having a hexagonal cross-section.

25. The method of claim 1, wherein the material is a granule having a size greater than 1 mm.

26. The method of claim 25, wherein said granules have a diameter/thickness ratio in the range of about 1 to 1.66.

27. The method of claim 25, wherein said granules are cylindrical in shape.

28. The method of claim 25, wherein said granules have a shape selected from the group consisting of cubes, rectangle parallelepipeds and elongated.

29. The method of claim 25, wherein said granules have a diameter in the range of about 1 mm to 5 mm.

30. The method of claim 25, wherein said granules have a thickness in the range of about 1 mm to 3 mm.

31. The method of claim 1, wherein said material has a porosity ranging between about 20% and about 40%.

32. A method of purifying a porous material comprising the step of using a gas flow through a porous material having an open porosity, said material comprising interconnected porosity channels, wherein the gas flow passes through said interconnected porosity channels of the material and removes impurities from the material through said porosity channels.
